(19) United States
(12) Patent Application Publication
(10) Pub. No.: US 2026/0025580 A1
(43) Pub. Date: Jan. 22, 2026

(54) CONTRAST-BASED AUTOFOCUS

(71) Applicant: Arm Limited, Cambridge (GB)

(72) Inventor: Dumidu Sanjaya Talagala, Coventry (GB)

(73) Assignee: Arm Limited, Cambridge (GB)

(21) Appl. No.: 19/270,417

(22) Filed: Jul. 15, 2025

(30) Foreign Application Priority Data
Jul. 22, 2024 (GB) 2410670.0

(51) Int. Cl. H04N 23/67; H04N 23/741

(52) U.S. Cl. CPC H04N 23/673; H04N 23/741

(57) ABSTRACT

The present disclosure relates to a method of contrast-based autofocus of an image capture device, the method comprising: determining if at least one initiation condition is met, comprising: obtaining a first contrast metric representative of a contrast characteristic of at least one region of a first image captured with a first focus setting, the first contrast metric being determined based on one or more first data values corresponding to one or more pixels of the first image; determining a change in the contrast characteristic of the at least one region of the first image based on the first contrast metric with respect to a reference contrast metric obtained from a previous image captured with the first focus setting; determining if the change in the contrast characteristic equals to or exceeds an initiation threshold for the first focus setting, wherein the initiation threshold for the first focus setting is set based at least in part on the first focus setting; and upon determining that at least one initiation condition is met, initiating an autofocus process.

### FIELD

The present invention relates to contrast-based autofocus of an image capture device.

### BACKGROUND

In general, image capture devices such as smartphone cameras or digital cameras comprise a lens to focus images onto an image sensor which captures the images. To enhance the image quality of a captured image, a focus setting of an image capture device can be adjusted appropriately, so that the image is in focus in the plane of the image sensor. The focus setting may for example be the position of a lens of the image capture device relative to an image sensor of the image capture device.

It is known to control the focus setting of an image capture device using a process known as contrast-based autofocus (AF). Contrast-based AF may be performed by measuring contrast within an image of a scene captured by an image sensor with a number of different focus settings. Typically, changing the focus setting of an image capture device may involve changing the position of a lens relative to an image sensor of the image capture device. The contrast generally increases as the focus of the image capture device improves. The focus setting used to capture the image with the highest contrast may be used as the focus setting for the image capture device for capturing subsequent images of the scene.

It is desired to improve contrast-based autofocus methods and systems.

### SUMMARY

An aspect of the present technology provides a method of contrast-based autofocus of an image capture device, the method comprising: determining if at least one initiation condition is met, comprising: obtaining a first contrast metric representative of a contrast characteristic of at least one region of a first image captured with a first focus setting, the first contrast metric being determined based on one or more first data values corresponding to one or more pixels of the first image; determining a change in the contrast characteristic of the at least one region of the first image based on the first contrast metric with respect to a reference contrast metric obtained from a previous image captured with the first focus setting; determining if the change in the contrast characteristic equals to or exceeds an initiation threshold for the first focus setting, wherein the initiation threshold for the first focus setting is set based on the first focus setting; and upon determining that at least one initiation condition is met, initiating an autofocus process.

When an image capture device is in focus, e.g. when a particular focus setting (e.g. determined by a lens position relative to an image sensor) gives a contrast metric that is at or close to a contrast peak, the image capture device generally remains at the particular focus setting until it is required to re-focus, for example, when an object in a scene being captured by the image capture device moves, or when the image capture device itself (or a user) moves. It is generally undesirable to adjust the focus setting of an image capture device frequently as constant focus adjustment distracts the user and causes difficulties in capturing an image. According to embodiments of the present technology, an autofocus process is initiated only when at least one initiation condition is met.

The Applicant has recognised that when the object on which an image capture device is focussed is far away, the range of focus settings (e.g. lens positions) capable of producing an acceptable focus is large; in other words, a given focus setting can accommodate a large range of distance between the object and the image capture device before the focus of the image capture device needs to be adjusted. On the other hand, when the object on which the image capture device is focussed is close up, the range of focus settings (e.g. lens positions) capable of producing an acceptable focus is significantly smaller, and contrast can fall rapidly on either side of the optimal focus setting. Thus, a small change in the position of the close-up object has a significant impact on contrast and necessitates a change of focus setting. Thus, according to embodiments of the present technology, an initiation threshold used for determining an initiation condition for initiating an autofocus process is set based on (or at least partially dependent on) the current focus setting of the image capture device. In doing so, it is possible to reliably determine an appropriate condition for initiating an autofocus process.

Instead of setting the initiation threshold as an absolute value, e.g. of contrast metric, setting the initiation threshold as a ratio to the current peak contrast metric, i.e. the contrast metric obtained when the current focus setting was selected, allows the initiation condition to be determined based on current conditions. For example, different lighting conditions may result in different contrast metrics at the same focus setting, and using an initiation threshold that is relative to the current peak contrast metric reduces the likelihood of unnecessarily or undesirably triggering autofocus. Thus, in some embodiments, the reference contrast metric may substantially correspond to a peak contrast metric of the first focus setting, and the initiation threshold may be set as a ratio to the reference contrast metric. In some embodiments, the reference contrast metric may correspond to a running mean contrast. In some embodiments, an absolute value of a change in contrast may be set as the initiation threshold.

As discussed above, when a given focus setting is set for a distant object, such that the given focus setting has a wide depth of field, the contrast metric of the given focus setting typically varies slowly over a large range of changes in the position of the object. On the other hand, when a given focus setting is set for a close-up object (macro), such that the given focus setting has a narrow depth of field, the contrast metric of the given focus setting can vary greatly over a small range of changes in the position of the object. Thus, so as to avoid triggering autofocus undesirably frequently, in some embodiments, the initiation threshold may be set based on a depth of field of the first focus setting, such that a relatively higher initiation threshold may be set for a narrower depth of field, and a relatively lower initiation threshold may be set for a wider depth of field. In doing so, it is possible to set an initiation threshold that varies according to the depth of field that is a (direct or indirect) result of the current focus setting.

When at least one initiation condition is met, an autofocus process is initiated to search for a suitable focus setting. In some embodiments, initiating an autofocus process may comprise obtaining a second contrast metric representative of the contrast characteristic of a region of a second image corresponding to the at least one region of the first image, the second image being captured with a second focus setting, and the second contrast metric being determined based on one or more second data values corresponding to one or more pixels of the second image.

Since the rate of change in contrast is lower for an object moving towards infinity compared to when it is moving towards a macro position, it may be assumed that a change in contrast is more likely due to the object moving towards macro. Thus, in some embodiments, the second focus setting may have a narrower depth of field than the first focus setting.

In some embodiments, the method may further comprise assessing a contrast behaviour of the second focus setting based on the second contrast metric with respect to the first contrast metric.

In some embodiments, assessing a contrast behaviour may comprise: determining that the second contrast metric is greater than the first contrast metric; and obtaining a third contrast metric representative of a contrast characteristic of a region of a third image corresponding to the at least one region of the first image, the third image being captured with a third focus setting, and the third contrast metric being determined based on one or more third data values corresponding to one or more pixels of the third image, the third focus setting having a narrower depth of field than the second focus setting. When it is determined that shifting the focus setting towards macro improves contrast, it may be assumed that shifting the focus setting further towards macro will continue to improve contrast until peak contrast is reached.

In some embodiments, assessing a contrast behaviour may comprise: determining that the second contrast metric is less than the first contrast metric; and obtaining a fourth contrast metric representative of a contrast characteristic of a region of a fourth image corresponding to the at least one region of the first image, the fourth image being captured with a fourth focus setting, and the fourth contrast metric being determined based on one or more fourth data values corresponding to one or more pixels of the fourth image, the fourth focus setting having a wider depth of field than the second focus setting. When it is determined that shifting the focus setting towards macro reduces contrast, it may be assumed that peak contrast lies further away from macro (or towards infinity) and thus shifting the focus setting away from macro will improve contrast.

In some embodiments, assessing a contrast behaviour may comprise: determining that the second contrast metric substantially equals the first contrast metric; and obtaining a third contrast metric representative of a contrast characteristic of a region of a third image corresponding to the at least one region of the first image, the third image being captured with a third focus setting, and the third contrast metric being determined based on one or more third data values corresponding to one or more pixels of the third image, the third focus setting having a narrower depth of field than the second focus setting. If adjusting the focus setting towards a macro position produce little to no change in the contrast metric, this suggests that the contrast at the new (second) focus setting is similar to the contrast at the old (first) focus setting; in that case, the focus setting may be further adjusted closer towards the macro position in order to continue assessing any changes in contrast.

It may be advantageous for the autofocus process to sweep or scan a range of focus settings in order to determine a focus setting that results in a substantially optimal, or at least acceptable, contrast. In some embodiments, initiating an autofocus process may comprise obtaining respective contrast metrics for a plurality of focus settings within a sweep range. This may include sampling one or more or all of the plurality of focus settings once, more than once or any suitable and desirable number of times. For example, the number of times a given focus setting is sampled may be dependent on its depth of field.

In some embodiments, a larger sweep range may be set when the change in the contrast characteristic exceeds the initiation threshold by a larger amount, or a smaller sweep range may be set when the change in the contrast characteristic exceeds the initiation threshold by a smaller amount. When there is a larger change in contrast, it may indicate that the object has moved by a large distance, and so it may be useful to search a larger range of focus settings in order to determine an appropriate focus setting to be used. Other modulation of the sweep range may be implemented alternatively or in addition to the above, for example based on the current focus setting.

In some embodiments, the method may further comprise assessing the plurality of focus settings within the sweep range to determine an operating focus setting based on the respective contrast metrics of the plurality of focus settings.

In some embodiments, assessing the plurality of focus settings may comprise determining a highest contrast metric amongst the respective contrast metrics of the plurality of focus settings.

In some embodiments, the method may further comprise terminating the autofocus process upon reaching at least one termination condition.

In some embodiments, the at least one termination condition may be reached when the highest contrast metric is determined.

There may be instances when the autofocus process switches back and forth between two focus settings with comparable contrast metrics while scanning a range of focus settings to search for peak contrast, unable to settle on one focus setting or the other. Thus, in some embodiments, the at least one termination condition may be reached when two contrast metrics respective of two focus settings are substantially equal and highest amongst respective contrast metrics of the plurality of focus settings, and the method may further comprise determining an intermediate focus setting between the two focus settings to be the operating focus setting. In doing so, when the highest contrast metric cannot be determined between two focus settings with comparable contrast metrics, the autofocus process can be terminated by selecting a sufficiently good focus setting to allow the user to capture an image.

Since at or near macro, small changes in focus setting can result in large changes in contrast, there may be instances, for example when the autofocus process attempts to focus on macro, when a small range (or a subset) of focus settings is being scanned back and forth but the autofocus process is unable to determine the highest (peak) contrast metric. Thus, in some embodiments, the at least one termination condition may be reached when the highest contrast metric cannot be determined amongst respective contrast metrics of a subset of focus settings of the plurality of focus settings, and the method may further comprise selecting a focus setting amongst the subset of focus settings to be the operating focus setting. In doing so, when the highest contrast metric cannot be determined amongst a subset of focus settings, the autofocus process can be terminated by selecting a sufficiently good focus setting to allow the user to capture an image.

In some embodiments, the method may further comprise establishing that the highest contrast metric cannot be determined when a time from initiating the autofocus process reaches a predetermined termination time period, and/or when a number of times two or a subset of focus settings amongst the plurality of focus settings have been assessed reaches a predetermined number limit.

There may be instances when an object comes into view briefly and a focus setting is selected to focus on the object, which subsequently moves away. The object moving away may not immediately trigger the autofocus process, for example if the initiation threshold is not reached. However, the image capture device may no longer be in focus due to the object moving away. Thus, in some embodiments, the at least one initiation condition may be reached when a time from terminating the autofocus process reaches a predetermined initiation time period. In doing so, it is possible to periodically confirm whether the image capture device remains sufficiently in focus or requires re-focussing. Such periodic check is also useful when the current focus setting is selected as a compromise between two comparable focus settings or a subset of focus settings when peak contrast cannot be determined. In such cases, the compromise focus setting may be reassessed to confirm whether it remains as a sufficiently good focus setting or a focus setting with better contrast may be determined.

The Applicant has recognised that variations in exposure may affect contrast. Thus, in some embodiments, the method may further comprise obtaining an exposure metric representative of an exposure characteristic of a scene corresponding to the at least one region of the first image.

In some embodiments, the method may further comprise determining whether the exposure characteristic of the scene changes continually based on the exposure metric, and upon determining that the exposure characteristic of the scene changes continually, causing the autofocus process to pause. Since variations in exposure can affect contrast, obtaining the contrast metric of a particular focus setting while exposure is changing may result in an inaccurate contrast measurement. By causing the autofocus process to pause (or preventing it from commencing), such inaccurate contrast measurements may be avoided.

In some embodiments, the method may further comprise commencing the autofocus process upon determining that there is no substantial change in the exposure characteristic of the scene. If it is determined that there are no substantial changes in exposure, or that changes in exposure have stopped, it can be assumed that contrast measurements made thereafter are the results of only changes in focus setting and not exposure. Thus, by pausing autofocus while exposure is changing and only commencing autofocus when there are no changes in exposure improves the confidence level and reliability of the resulting contrast measurements.

There may be more than one suitable way of adjusting the focus setting of an image capture device. In some embodiments, initiating an autofocus process may comprise adjusting a focus setting of the image capture device by changing a position of a lens of the image capture device relative to an image sensor of the image capture device.

Another aspect of the present technology provides a non-transitory computer-readable medium comprising machine-readable code which, when executed by a processor, causes the processor to perform the method as described above.

A further aspect of the present technology provides an apparatus for processing image data, the apparatus comprising processing circuitry to: determine if at least one initiation condition is met, by: obtaining a first contrast metric representative of a contrast characteristic of at least one region of a first image captured with a first focus setting, the first contrast metric being determined based on one or more first data values corresponding to one or more pixels of the first image; determining a change in the contrast characteristic of the at least one region of the first image based on the first contrast metric with respect to a reference contrast metric obtained from a previous image captured with the first focus setting; determining if the change in the contrast characteristic equals to or exceeds an initiation threshold for the first focus setting, the initiation threshold for the first focus setting being set based on the first focus setting; and upon determining that at least one initiation condition is met, initiate an autofocus process.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Embodiments will now be described, with reference to the accompanying drawings, in which:

FIG. 1 shows a flow diagram of an exemplary method of determining a focus setting for an image capture device;

FIG. 2 shows schematically an exemplary relationship between a focus metric and a focus setting;

FIG. 3 shows a flow diagram of an exemplary contrast-based autofocus process;

FIG. 4 shows a flow diagram of an exemplary method for performing contrast-based autofocus according to embodiments;

FIG. 5 shows a flow diagram of an exemplary method for performing contrast-based autofocus based on initiation conditions;

FIG. 6 shows a flow diagram of an exemplary method for performing contrast-based autofocus based on contrast behaviour;

FIG. 7 shows a flow diagram of an exemplary method for determining a focus setting for an image capture device; and

FIG. 8 shows schematically an exemplary image processing system.

### DETAILED DESCRIPTION

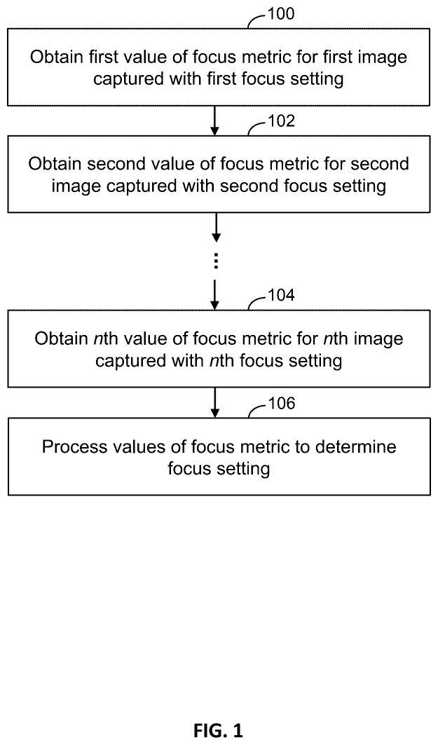

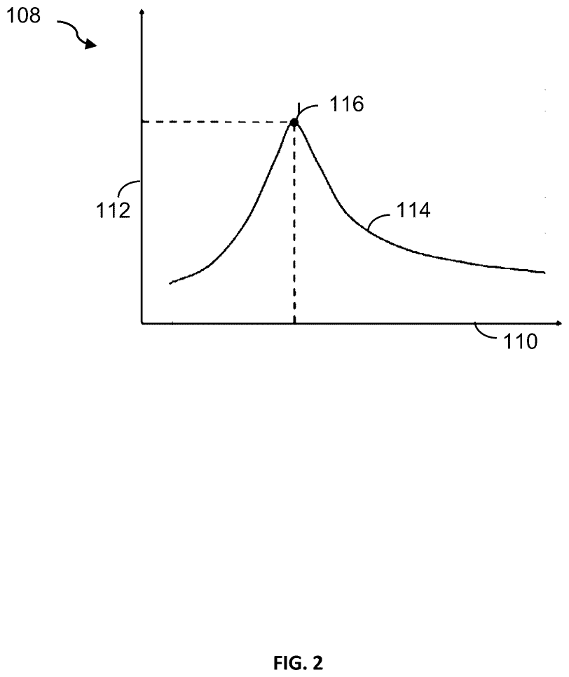

To put the examples herein into context, an example of contrast-based autofocus (AF) will be described generally, with reference to FIGS. 1 and 2.

Introduction to contrast-based autofocus

FIG. 1 is a flow diagram showing a method of determining a focus setting for an image capture device according to examples. The method is for contrast-based AF, which is for example an iterative process in which a focus setting for an image capture device is determined based on a value of a focus metric (e.g. contrast). The image capture device may for example be a smartphone camera, a standalone digital camera, a digital camera coupled to, or incorporated in, a further electronic device or a computer. The focus setting may for example be the position of a lens of the image capture device relative to an image sensor of the image capture device. The sharpness of an image captured by the image capture device typically depends on the focus setting. Hence, by determining the appropriate focus setting, images of a scene (or a region of interesting within the scene) can be captured which appear sharp, rather than diffuse or blurry.

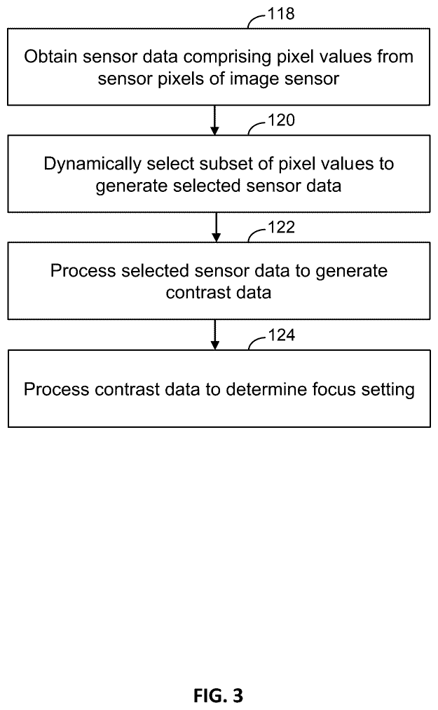

At item 100 of FIG. 1, a first value of a focus metric is obtained for a first image captured by the image capture device with a first focus setting. Various different focus metrics may be used. For contrast-based AF, the focus metric for example may represent or otherwise depend on, or be based on, a contrast within a captured image. Contrast is for example a difference in luminance and/or colour within an image (or image portion). A maximum contrast within an image (e.g. representing a difference between a maximum luminance and a minimum luminance) may be referred to as the contrast ratio or dynamic range. Contrast generally relates to relative differences rather than absolute values of luminance and/or colour, as the human visual system is more sensitive to these relative differences than absolute values of luminance and/or colour. Examples of generation of contrast data representative of a contrast-based characteristic of at least a portion of an image, for use in contrast-based AF, are described further with reference to FIG. 3.

At item 102, a second value of the focus metric is obtained for a second image captured by the image capture device with a second focus setting. For example, the first image may be captured with the lens in a first position relative to the image sensor (such as with a first distance between a vertical axis of the lens and a vertical axis of the image sensor). The second image may be captured with the lens in a second position relative to the image sensor, which is different from the first position, such as at a second distance between the vertical axes of the lens and image sensor, respectively.

This process may be repeated iteratively until a plurality of images have been taken with a plurality of different focus settings, such as a plurality of different distances between the lens and the image sensor. Then, at item 104, an nth value of the focus metric is obtained for an nth image captured by the image capture device with an nth focus setting, where n is an integer and may be predetermined or pre-set. Alternatively, the value of n may be determined during the contrast-based AF process. For example, it may be determined that capture of further images is to cease once the value of the focus metric has reached a particular value or has altered by a certain absolute or relative amount (e.g. a percentage) compared to one or more previous values. For example, a hill-climbing algorithm may be used to obtain a plurality of focus metric values in a step-by-step fashion, for a plurality of different focus settings, while monitoring the change in the focus metric value. After the value of the focus metric drops by a certain percentage or more, after stepping through one or more different focus settings, it may be determined that the focus setting to use for subsequent image capture has been passed. Capture of subsequent images with further focus settings may therefore cease.

At item 106, the values of the focus metric are processed to determine the focus setting to use for the image capture device for subsequent capture of images of the scene. The value of the focus metric may be at a maximum, or close to a maximum, when the image captured by the image capture device with a particular focus setting is in focus. That particular focus setting may then be selected as the focus setting to use for subsequent image capture, and may be considered to be an optimal focus setting for capture of the scene.

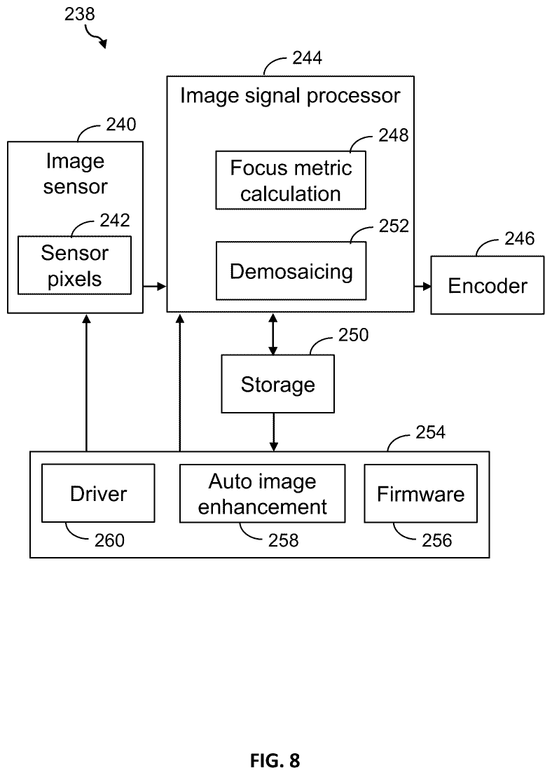

FIG. 2 is a graph 108 showing schematically the relationship between a focus metric and a focus setting, which in the present example is a lens position of the lens of the image capture device. The x-axis 110 of the graph 108 shows the lens position relative to the image sensor and the y-axis 112 of the graph 108 shows the value of the focus metric. The curve 114 is obtained by fitting a polynomial to a plurality of values of the focus metric obtained for a plurality of lens positions during a contrast-based AF process. The curve 114 of is an idealised curve, which has a peak point 116 corresponding to a maximum value of the focus metric. The lens position to use for the image capture device may be taken as the lens position corresponding to this peak point 116. The peak point 116 may be found analytically based on the curve 114. However, other examples may not involve the fitting of a curve to the obtained focus metric values. In such examples, the focus setting to use for subsequent image capture may for example be taken as the focus setting corresponding to the largest focus metric value obtained during the contrast-based AF process. Further examples of determining a focus setting are described in detail with reference to FIG. 8.

### Generation of Contrast Data for Contrast-Based Autofocus

FIG. 3 is a flow diagram showing a method for contrast-based AF of an image capture device according to examples. At item 118, sensor data representative of an image captured by the image capture device is obtained. The image represented by the sensor data may be the entire image captured by the image capture device or a portion of a larger image. The sensor data is representative of a particular contrast characteristic (e.g. intensity, difference) and is derived from pixel values from respective sensor pixels of an image sensor of the image capture device. An image sensor typically includes an array of sensor pixels, which may be any suitable photosensors for capturing images. For example, a typical sensor pixel includes a photosensitive element such as a photodiode that can convert incident light into electronic signals or data. The sensor pixel may for example be a charge-coupled device (CCD) or a complementary metal-oxide-semiconductor (CMOS).

The sensor data can be derived from pixel values obtained from the image sensor and for example represent at least one characteristic of the light captured by the image sensor. For example, the sensor data may be representative of an intensity of the light captured by each sensor pixel, which may be proportional to the number of photons captured by that sensor pixel. The intensity may represent a luminance of the captured light, which is for example a measure of the intensity of light per unit area rather than an absolute intensity. In another example, the sensor data may be representative of a brightness of captured light, which may be considered to correspond to a perception of a luminance, which may or may not be proportional to the luminance. In another example, the sensor data may be representative of a difference or edge in the captured light, which may be regarded as corresponding to a luminance gradient or a measure of discontinuities in luminance. In general, the sensor data may represent any photometric quantity or characteristic that may be used to represent the visual appearance of the image represented by the sensor data.

At item 122, the selected sensor data is processed to generate contrast data representative of a contrast-based characteristic of at least a portion of the image. A contrast-based characteristic may for example be any feature of the image (or a portion of the image) which is representative of a contrast of the image or which allows a contrast to be determined or otherwise derived. There are many different contrast-based characteristics that may be used. For example, contrast-based characteristics may represent variations in a spatial or frequency domain of an image, such as edges in an image.

At item 124, the contrast data is processed to determine a focus setting for the image capture device. The contrast data may represent a value of a focus metric, which may be used to obtain a focus setting for example as described with reference to FIGS. 1 and 2. Alternatively, the contrast data may be processed to obtain a value of the focus metric, which may in turn be used to obtain the focus setting for example as described with reference to FIGS. 1 and 2.

Typically, when an image capture device is in focus, e.g. when a particular focus setting (e.g. determined by a lens position relative to an image sensor) gives a contrast metric that is at or close to a contrast peak, the image capture device remains at that focus setting until it is required to re-focus—for example, when an object being captured by the image capture device moves, or when the image capture device itself (or the user) moves. It is generally desired to reduce the frequency of adjusting the focus setting of an image capture device, as constant focus adjustment distracts the user and causes difficulties in capturing an image. Thus, embodiments of the present technology provide improved methods of contrast-based autofocus for an image capture device.

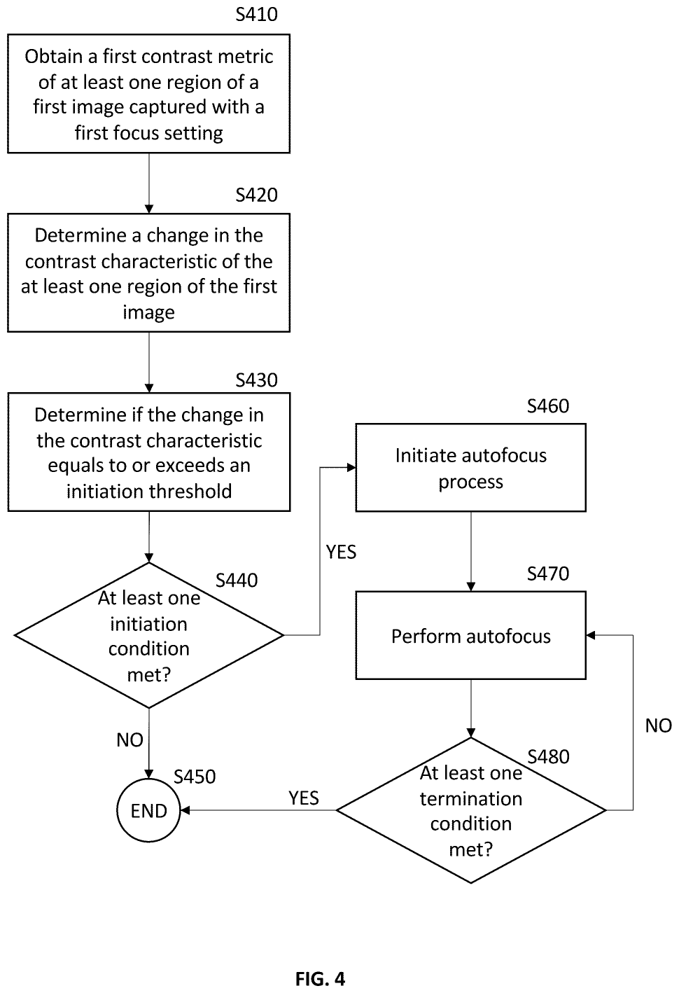

FIG. 4 shows a flow diagram illustrating a method 400 of contrast-based autofocus for an image capture device according to the embodiments. The present method monitors if and when at least one initiation condition is met, and begins at S410 by obtaining a first contrast metric representative of a contrast characteristic of at least one region of a first image captured with a first focus setting. The first contrast metric may e.g. be determined based on one or more first data values corresponding to one or more pixels of the first image, for example respective of pixels of an image sensor of the image capture device.

At S420, a change in the contrast characteristic of the at least one region of the first image is determined based on the first contrast metric with respect to a reference contrast metric obtained from a previous image captured with the first focus setting. Herein, the reference contrast metric may be the most recent or previous peak contrast metric, a moving or running average (or mean) contrast metric (for the same focus setting), or any other suitable or desirable fixed or moving contrast metric or measures.

At S430, it is determined whether the change in the contrast characteristic equals to or exceeds an initiation threshold for the first focus setting. In the present method, the initiation threshold for the first focus setting is set based on the first focus setting.

At S440, it is determined whether at least one initiation condition is met, which, in the present method, includes the change in the contrast characteristic equals to or exceeds the initiation threshold for the first focus setting.

If it is determined that at least one initiation condition is not met, for example the change in the contrast characteristic is less than the initiation threshold for the first focus setting, the method ends at S450 and the method continues to monitor one or more initiation conditions.

Upon determining that at least one initiation condition is met, an autofocus process is initiated at S460.

Autofocus process is performed at S470 to search for a suitable or optimal focus setting, such as one that gives a contrast metric at or near peak contrast.

The autofocus process continues until at least one termination condition is met at S480, then the autofocus process ends at S450. An example of a termination condition may be when peak contrast is reached at a particular focus setting.

According to embodiments of the present technology, an autofocus process is initiated only when at least one initiation condition is met. The Applicant has recognised that when the object on which an image capture device is focussed is far away, the range of focus settings (e.g. lens positions) capable of producing an acceptable focus is large; in other words, a given focus setting can accommodate a large range of distance between the object and the image capture device before the focus of the image capture device needs to be adjusted. On the other hand, when the object on which the image capture device is focussed is close up, the range of focus settings (e.g. lens positions) capable of producing an acceptable focus is significantly smaller, and contrast can fall rapidly on either side of the optimal focus setting. Thus, a small change in the position of the close-up object has a significant impact on contrast and necessitates a change of focus setting. Thus, according to embodiments of the present technology, an initiation threshold used for determining an initiation condition for initiating an autofocus process is set based at least in part on (or at least partially dependent on) the current focus setting of the image capture device. In doing so, it is possible to reliably determine an appropriate condition for initiating an autofocus process.

As discussed above and will be discussed in further details below, one or more initiation conditions may be set which, when at least one is met, triggers an autofocus process. An initiation condition may be set based on a change in the contrast characteristic meeting an initiation threshold. In the embodiments, when a change in contrast characteristic equals to or exceeds an initiation threshold, autofocus may be triggered to search for a more optimal focus setting, e.g. by repositioning a lens of the image capture device relative to an image sensor. In an embodiment, the initiation threshold may be expressed in terms of the last-measured peak contrast, for example as a percentage of the peak contrast, or a moving average of the contrast. In another embodiment, the initiation threshold may be dependent or based on a current gain. In yet another embodiment, the initiation threshold may be dependent or based on a current exposure. In other embodiments, one or more variables other than focus setting (e.g. lens position), contrast, gain or exposure may be included in the determination of the initiation threshold as desired. It should be appreciated that the initiation condition may be dependent on one or more of such variables, and the initiation threshold may be set based on one or more of these variables independently or in any combinations. It should be noted that, in some embodiments, a single trigger (meeting at least one initiation condition once) may be sufficient to initiate autofocus; in other embodiments, multiple triggers (meeting at least one initiation condition more than once and/or meeting more than one initiation condition) may be required to initiate autofocus. For example, in low light or high gain scenarios, contrast statistic may be less robust and requiring multiple triggers may reduce the number of unnecessary autofocus initiations.

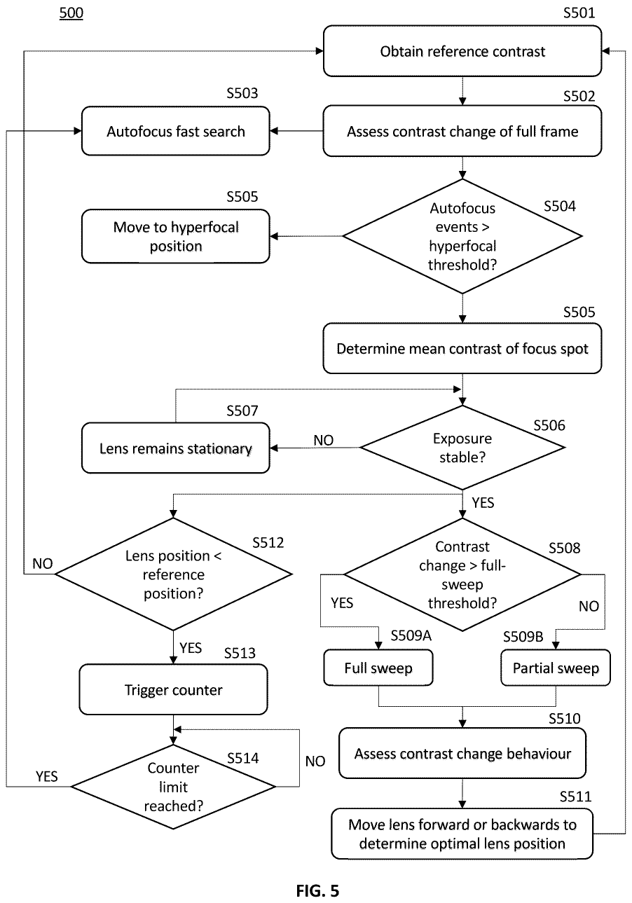

Turning to FIG. 5, an embodiment of a method 500 of contrast-based autofocus is shown. In the present embodiment, a focus setting is defined by a position of a lens of an image capture device relative to an image sensor of the image capture device. The method 500 begins when the lens is at a given position, i.e. the image capture device is set with a given focus setting. At S501, a reference contrast is generated by obtaining contrast statistics over a predetermined number of frames. During this period, the lens position is fixed and not altered over the predetermined number of frames to enable the reference contrast to be generated. At S502, changes in contrast are assessed for the full frame by comparing with an initiation threshold; in particular, the initiation threshold is determined based on the current lens position. If a change in contrast equals to or exceeds the relevant initiation threshold, autofocus is initiated.

Multiple initiation conditions may be assessed. For example, a change in contrast may be assessed based on full-frame contrast measurements, on specific spots (such as the original in-focus spot), on an image centre-weighted contrast measurement, or a different (weighted) combination of all spots covering an object, etc. In a particular embodiment, the initiation threshold may be set as a percentage of peak contrast, e.g. 20%, 40%, and the percentage may vary dependent on the current focus setting (current position of the lens). In terms of absolute value of contrast, the initiation threshold is set larger closer to macro, and smaller as the focus moves towards infinity. However, this may not be the case when considering the initiation threshold in relative terms (e.g. a ratio or percentage). Doing so can reduce unnecessary sweeps occurring close to macro while ensuring changes such as movements of an object are detected at longer distances.

There may two possible actions that can be triggered: 1) a smaller change in contrast may trigger a smaller autofocus sweep, S503 (based on a smaller range of focus settings or lens positions); or 2) a larger change in contrast may trigger a sweep of the full range of lens positions.

There may be instances when a small range of lens positions (or a subset of focus settings) is being swept/scanned back and forth as the autofocus process is unable to settle on an optimal lens position, for example when focussing on macro and the rapid variations in contrast means peak contrast cannot be found. To address such an issue, the number of times (or total amount of time) the lens is being repositioned, i.e. the number of autofocus events, may be counted, such that, at S504, if the number of autofocus events exceeds a predetermined hyperfocal threshold, the method proceeds to move the lens to a hyperfocal position that is deemed at a sufficiently good focus setting that produces an acceptable contrast (albeit not peak).

Thereafter, contrast (or mean contrast) is assessed at S505, for example for a specific spot (e.g. an in-focus spot) or full frame, to determine if further adjustments are required.

The Applicant has recognised that changes in exposure may impact on contrast. A change in exposure may indicate a change in the scene itself. Thus, in the present method, at S506, the scene being captured is assessed to determine whether exposure is stable or is changing. When it is determined that exposure is changing, autofocus process is paused such that the lens remains stationary at S507 until exposure stabilizes, at which point contrast measurements also stabilize.

Then, when it is determined that exposure is stable (not changing), at S508, the change in contrast is assessed for full sweep. In particular, the change in contrast may be compared with a predetermined full-sweep threshold to determine if a sweep of the full range of lens positions is to be performed. In some situations, it may be desirable to perform a full sweep irrespective of the magnitude of contrast change, e.g. if exposure has changed (or changed significantly).

If the change in contrast is determined to exceed (or at least equal) the full-sweep threshold at S508, the method proceeds to S509A to first move the lens to an infinity (furthest) position, then progressively move the lens towards a macro position. Otherwise, a partial sweep is initiated at S509B, in which the lens is moved towards macro from its current position. The rate of change in contrast is slower toward infinity compared to the macro position. Therefore, it may be assumed that a change in contrast is more likely to be triggered by an object moving towards macro (i.e., towards the lens) than towards infinity. Thus, when a partial sweep is triggered, the lens is moved towards macro.

As the position of the lens changes, contrast is measured at different lens positions to determine a contrast peak. As the contrast of each lens position is measured, the behaviour of the changes in contrast is also assessed at S510. For example, changes in contrast may be assessed for falling contrast, rising contrast, or indeterminate (e.g. when it is not clear whether contrast is falling or rising).

At S511, if it is assessed that contrast is rising, then the autofocus process continues to search for an optimal lens position in the current direction (e.g. towards macro), or if it is assessed that contrast is falling, then the autofocus process reverses the direction of the search (e.g. away from macro). When it is indeterminate, such that contrast is neither clearly rising or clearly falling, the autofocus process may first continue moving the lens in the same direction to determine if there are any changes to contrast, then, if there are no change in contrast again, it may be assumed that contrast peak is reached.

When contrast peak is reached, a termination condition is reached and autofocus ends by setting the focus setting as the lens position that results in the contrast peak.

There may be a scenario in which the autofocus process sweeps back and forth between two lens positions multiple times and can neither determine peak contrast nor a direction to continue sweeping. In such a scenario, a termination condition may be set to end the autofocus process by setting the lens at an intermediate position between the two positions, and the process awaits the next initiation of the autofocus process when at least one initiation condition is met.

Returning to S506, while (or after) determining whether exposure is stable, the lens position may be checked against a reference position to determine if the lens position is closer to macro than the reference position. When the focus of an image capture device is very close to macro, i.e. focussed on an object or region very close to the image capture device, it is possible for the image capture device to be unable to detect a change in contrast and/or unable to reach peak contrast when re-focussing due to a number of reasons. Since contrast can vary rapidly with changes in focus setting when attempting to focus on macro, contrast can fall sharply on either side of a contrast peak, such that, if focus settings are sampled too sparsely, an optimal focus setting may be missed. For the same reason, if an object at macro is moving, this would increase the difficulty in searching for a contrast peak. Moreover, the number of objects in view at macro is typically small; thus, if an object very close to the image capture device is a low contrast object (e.g. a jacket sleeve or something similarly uniform), when the object moves away abruptly, the background scene may still produce a similar (low) contrast measurement that does not trigger autofocus.

Thus, when the lens is stationary and closer to macro than the reference position, a counter may be set at S513 to track the amount of time the lens remains stationary. When the counter limit (i.e. a time limit) is reached (initiation condition), autofocus (e.g. fast search) may be triggered to either confirm that the current lens position is still optimal or reposition the lens to a more optimal position. It should be noted that the function of tracking an elapse time when the lens is stationary is not limited to when the lens is close to macro; similar tracking of elapse time may be used to trigger the autofocus process whenever the lens is stationary.

Embodiments of the present technology further provides a state machine and method for assessing contrast behaviour e.g. of each image zone at each focus setting (e.g. lens position), and a mechanism to determine whether to exit a single-shot autofocus sweep (when a termination condition is met during sweeping of a lens position range when a contrast peak is found). Herein, contrast behaviour refers to how contrast or contrast statistics/measurements change as a result of changes in focus settings.

In particular, image zones may be classified into different contrast condition: rising contrast, falling contrast or unclear/indeterminate. The classifications may for example be defined with respect to a reference contrast specific to each image zone e.g. as a ratio or as an absolute deviation from the reference contrast. The reference contrast may for example be the most recent peak or maximum contrast determined for that image zone, or the preceding contrast obtained for that image zone (including immediately preceding the currently obtained contrast or any number of preceding contrast metrics). The classification of an “unclear/indeterminate” state is particularly relevant when focussing close to macro.

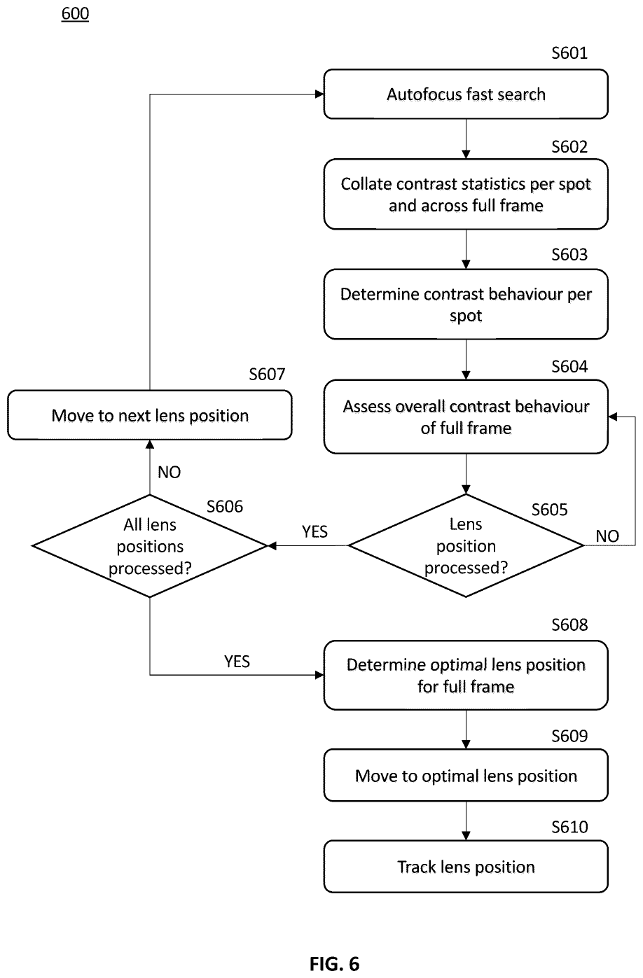

FIG. 6 shows a flow diagram illustrating an exemplary decision-making process based on contrast behaviour, according to an embodiment. Method 600 begins at S601, at which autofocus is triggered, for example as described by FIG. 5.

At S602, contrast measurements of each spot of a frame are collated across the whole frame, for example by performing a weighted sum of the contrast measurements at each spot.

At S603, contrast behaviour at each spot is determined. In particular, the contrast metric/measurement of a given spot at the current focus setting (lens position) may be compared with the contrast metric/measurement of the same spot at a previous focus setting to determine whether contrast is rising, falling or stable (unclear/indeterminate). The change in contrast metric for the given spot between two focus settings may be compared with a termination threshold, such that, for example, if a rise in contrast equals to or exceeds the termination threshold, or the contrast is determined to be falling or stable, a termination condition is met (for the given spot) and an optimal/peak contrast is determined based on the contrast metric of the current focus setting and the contrast metric of the previous one, two or more focus settings.

Spots for which an optimal (or substantially optimal) focus setting is found is tracked over time, and at S604, the overall contrast behaviour for the full frame is assessed. In particular, whether a majority of spots within the frame have met the termination condition is determined. Then, an assessment for an optimal, or at least suitable, focus setting (e.g. lens position) may be performed based e.g. on the majority focus setting that meets the termination condition, or a weighted average. In some cases, it may be advantageous to assess whether a prioritized image zone or spot (if any), e.g. a region of interest (ROI) selected by a suitable algorithm or by the user, shows a rise in contrast or a fall in contrast, which may be used to override the previous assessment.

If there remain one or more spots within the frame that have not met the termination condition, then at S605, it is determined whether all spots in the frame have been processed for the current lens position.

If the current lens position has been processed, then at S606, it is determined whether all lens positions within the range have been processed. If there remain one or more lens positions that have not been processed, at S607, it proceeds to the next lens position for contrast measurements and assessment.

If all lens positions have been processed, then at S608, an optimal (or suitable) lens position (focus setting) is determined for the full frame, e.g. based on an assessment similar to S604. For example, the lens position that corresponds to a peak contrast for a spot closest to a macro position may be selected. This may be applied to spots where the contrast behaviour for the spots shows falling contrast. In cases where a priority image zone or spot is defined, and the priority image zone or spot has an optimal focus setting (lens position) that is greater than the former case, the former selection is overridden to prioritize the focus setting of the priority image zone or spot. This may be applied to priority spot where the contrast behaviour for the spot is unclear/indeterminate (stable).

In cases where all or substantially all spots and full-frame image zones are of low-contrast and peak contrast cannot be determined, then the focus setting corresponding to the most optimal contrast that is close to macro in the centre-weighted zone in the full frame, or the focus setting corresponding to the centre spot may be used.

When a suitable or optimal focus setting is determined or selected, at S609, the lens is moved to the selected position.

The process ends at S610 with the tracking of the new lens position, e.g. to detect when at least one initiation condition (e.g. a fall in contrast) is met.

### Determination of Focus Setting Using Contrast Data

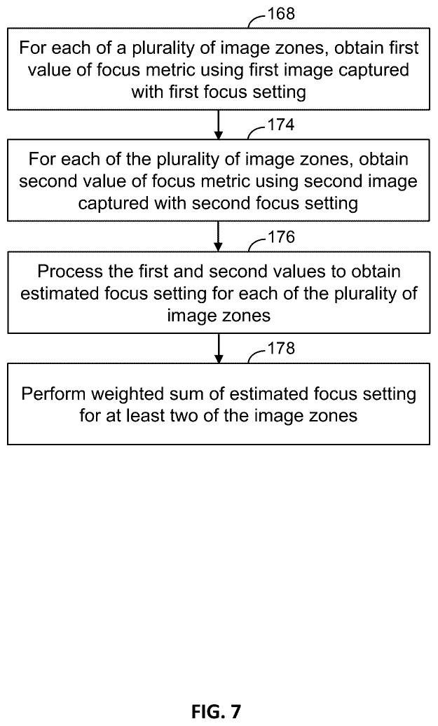

FIG. 7 is a flow diagram showing an exemplary method of determining a focus setting for an image capture device. The method begins at item 168, where, for each of a plurality of image zones, a first value of a focus metric for the respective image zone is obtained using a first image captured with a first focus setting for the image capture device. The first image may be divided into zones in any suitable manner. In some examples, each of the image zones may be the same size as each other; however, in other examples, some of the image zones may be different sizes than others. For example, an image may be divided into image zones based on processing of the image, e.g. to identify at least one ROI (region of interest).

At item 174, for each of a plurality of image zones, a second value of the focus metric for the respective image zone is obtained using a second image captured with a second focus setting for the image capture device. The contrast data obtained e.g. as described with reference to FIG. 3 may represent the focus metric for example. In other cases, the present method may be performed with a different focus metric.

At item 176, the first value and the second value are processed, for each of the plurality of image zones, to obtain an estimated focus setting for the respective image zone. The first and second values may be processed in various different ways to obtain the estimated focus setting.

At item 178, the focus setting is determined by performing a weighted average of the estimated focus setting for at least two of the plurality of image zones, e.g. in cases where a focus setting refers to a position or distance of a lens of the image capture device relative to an image sensor of the image capture device. The weighted average may for example account for different image characteristics of the at least two of the plurality of image zones, for example such that image zones corresponding to a ROI receive a higher weighting than other image zones; in some cases, image zones corresponding to a ROI may receive a weighting of 1 while other image zones may receive a weighting of 0.

An average estimated focus setting, for example corresponding to the central value of the distribution of the estimated focus settings, may be obtained using at least two estimated focus settings, and in some cases all of the plurality of estimated focus settings. The average estimated focus setting may be a mean, mode or median, for example.

### Image Processing System

The examples described herein may be implemented using an image processing system, for example image processing system 238 as illustrated schematically in FIG. 8.

The image processing system 238 includes an image sensor 240. The image sensor 240 includes sensor pixels 242 for capturing light. Light received at the image sensor 240 is converted to image data. The image data is transferred to an image signal processor 244, which is typically configured to generate output image data representative of at least part of an output image. The output image data may be encoded via an encoder 246 before being transferred to other components, for example for storage or further processing. The image signal processor 244 typically includes a number of units that are configured to perform various processing on the image data, to generate the output image data. Image signal processors such as the image signal processor 244 may include a microprocessor, a general-purpose processor, a digital signal processor (DSP), an application specific integrated circuit (ASIC), a field programmable gate array (FPGA) or other programmable logic device, a discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The image signal processor 244 in the present example is arranged to calculate a value of a focus metric such as those described herein, and may therefore be considered to include a focus metric calculation unit 248. Data for use in, or generated as part of, the focus metric calculation unit 248 may be stored in storage 250 of the image processing system 238. The storage 250 may include at least one of volatile memory, such as a Random Access Memory (RAM) and non-volatile memory, such as Read Only Memory (ROM) or a solid state drive (SSD) such as Flash memory. The storage 250 may for example be an on-chip memory or buffer that may be accessed relatively rapidly by the image signal processor 244. In other examples, the storage 250 may include further storage devices, for example magnetic, optical or tape media, compact disc (CD), digital versatile disc (DVD) or other data storage media. The storage 250 may be removable or non-removable from the image processing system 238. The storage 250 is communicatively coupled to the image signal processor 244 so that data can be transferred between the storage 250 and the image signal processor 244. For example, the storage 250 may store image data representative of at least a portion of an image (such as image data prior to demosaicing) as well as data generated during the calculation of a value of a focus metric, such as that described above.

The image signal processor 244 may also include a demosaicing system 252 for demosaicing image data for use in the focus metric calculation 248. The demosaicing system 252 may be arranged to perform grayscale demosaicing to obtain a grayscale intensity at respective pixel positions from data obtained from the image sensor (for example Bayer data). For example, the demosaicing system 252 may obtain RGB data or it may obtain grayscale data. In such cases, the sensor data used to determine the focus setting may e.g. be the grayscale data obtained by the demosaicing system 252, which may be considered to correspond to values in a grayscale intensity plane Y. In other cases, the sensor data used to determine the focus setting may be the Bayer data itself obtained from the sensor pixels prior to undergoing demosaicing.

The image processing system 238 also includes a controller 254 for controlling features or characteristics of the image sensor 240. The controller 254 may include hardware or software components or a combination of hardware and software. For example, the controller 254 may include firmware 256 which includes software for controlling the operation of the controller 254. The firmware 256 may be stored in non-volatile memory of the controller 254 or in the storage 250 (which is accessible to the controller 254). The controller 254 also includes an auto image enhancement system 258, which for example is configured to perform processing to determine whether adjustments need to be made to the image processing system 238 to improve the image quality. For example, the auto image enhancement system 258 may include an auto exposure module (e.g. arranged to perform contrast-based autofocus), an auto white balance module and/or an auto focus module. For example, the auto image enhancement system 258 may include a focus controller, such as a contrast-based autofocus controller. In other cases, the focus controller may be a separate unit of the controller 254 and/or the auto image enhancement system 258 may be otherwise omitted. The controller 254 also includes a driver 260 for controlling the operation of the image sensor 240. For example, the driver 260 may control a configuration of the image sensor 240, such as a lens position, such that the image sensor 240 is in a configuration corresponding to a particular focus setting.

A data collection process, which may be referred to as a statistics collection process, may be performed using hardware, such as hardware of the controller 254 or of the image signal processor 238, such as by the focus metric calculation unit 248, which may obtain statistics (such as the contrast data) based on image data obtained by an image capture device including the image signal processor 238.

The processing of statistics, for example as described with reference to FIG. 7, to determine a focus setting for the image capture device, may for example be performed using firmware, such as the firmware 256 of the controller 254 or firmware associated with the image signal processor 244. This is not intended to be limiting, though; the focus setting may be determined using software, hardware or a combination of hardware and software, using various methods.

Components of the image signal processor 244 may be interconnected using a systems bus, which allows data to be transferred between the various components.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium.

A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. A method of contrast-based autofocus for an image capture device, the method comprising:
determining if at least one initiation condition is met, comprising:
obtaining a first contrast metric representative of a contrast characteristic of at least one region of a first image captured with a first focus setting, the first contrast metric being determined based on one or more first data values corresponding to one or more pixels of the first image;
determining a change in the contrast characteristic of the at least one region of the first image based on the first contrast metric with respect to a reference contrast metric obtained from a previous image captured with the first focus setting;
determining if the change in the contrast characteristic equals to or exceeds an initiation threshold for the first focus setting, wherein the initiation threshold for the first focus setting is set based at least in part on the first focus setting; and
upon determining that at least one initiation condition is met, initiating an autofocus process.

2. The method of claim 1, wherein the reference contrast metric substantially corresponds to a peak contrast metric of the first focus setting, and the initiation threshold is set as a ratio to the reference contrast metric.

3. The method of claim 1, wherein the initiation threshold is set based on a depth of field of the first focus setting, such that a relatively higher initiation threshold is set for a narrower depth of field, and a relatively lower initiation threshold is set for a wider depth of field.

4. The method of claim 1, wherein initiating an autofocus process comprises obtaining a second contrast metric representative of the contrast characteristic of a region of a second image corresponding to the at least one region of the first image, the second image being captured with a second focus setting, and the second contrast metric being determined based on one or more second data values corresponding to one or more pixels of the second image.

5. The method of claim 4, wherein the second focus setting has a narrower depth of field than the first focus setting.

6. The method of claim 5, further comprising assessing a contrast behaviour of the second focus setting based on the second contrast metric with respect to the first contrast metric.

7. The method of claim 6, wherein assessing a contrast behaviour comprises:
determining that the second contrast metric is greater than the first contrast metric; and
obtaining a third contrast metric representative of a contrast characteristic of a region of a third image corresponding to the at least one region of the first image, the third image being captured with a third focus setting, and the third contrast metric being determined based on one or more third data values corresponding to one or more pixels of the third image, the third focus setting having a narrower depth of field than the second focus setting; or
wherein assessing a contrast behaviour comprises:
determining that the second contrast metric is less than the first contrast metric; and
obtaining a fourth contrast metric representative of a contrast characteristic of a region of a fourth image corresponding to the at least one region of the first image, the fourth image being captured with a fourth focus setting, and the fourth contrast metric being determined based on one or more fourth data values corresponding to one or more pixels of the fourth image, the fourth focus setting having a wider depth of field than the second focus setting; or
wherein assessing a contrast behaviour comprises:
determining that the second contrast metric substantially equals the first contrast metric; and
obtaining a third contrast metric representative of a contrast characteristic of a region of a third image corresponding to the at least one region of the first image, the third image being captured with a third focus setting, and the third contrast metric being determined based on one or more third data values corresponding to one or more pixels of the third image, the third focus setting having a narrower depth of field than the second focus setting.

8. The method of claim 1, wherein initiating an autofocus process comprises obtaining respective contrast metrics for a plurality of focus settings within a sweep range.

9. The method of claim 8, wherein a larger sweep range is set when the change in the contrast characteristic exceeds the initiation threshold by a larger amount, or a smaller sweep range is set when the change in the contrast characteristic exceeds the initiation threshold by a smaller amount.

10. The method of claim 8, further comprising assessing the plurality of focus settings within the sweep range to determine an operating focus setting based on the respective contrast metrics of the plurality of focus settings.

11. The method of claim 10, wherein assessing the plurality of focus settings comprises determining a highest contrast metric amongst the respective contrast metrics of the plurality of focus settings.

12. The method of claim 11, further comprising terminating the autofocus process upon reaching at least one termination condition;
wherein the at least one termination condition is reached when the highest contrast metric is determined; or
wherein the at least one termination condition is reached when two contrast metrics respective of two focus settings are substantially equal and highest amongst respective contrast metrics of the plurality of focus settings, and the method further comprises determining an intermediate focus setting between the two focus settings to be the operating focus setting; or
wherein the at least one termination condition is reached when the highest contrast metric cannot be determined amongst respective contrast metrics of a subset of focus settings of the plurality of focus settings, and the method further comprises selecting a focus setting amongst the subset of focus settings to be the operating focus setting.

13. The method of claim 12, further comprising establishing that the highest contrast metric cannot be determined when a time from initiating the autofocus process reaches a predetermined termination time period, and/or when a number of times two or a subset of focus settings amongst the plurality of focus settings have been assessed reaches a predetermined number limit.

14. The method of claim 12, wherein the at least one initiation condition is reached when a time from terminating the autofocus process reaches a predetermined initiation time period.

15. The method of claim 1, further comprising obtaining an exposure metric representative of an exposure characteristic of a scene corresponding to the at least one region of the first image.

16. The method of claim 15, further comprising determining whether the exposure characteristic of the scene changes continually based on the exposure metric, and upon determining that the exposure characteristic of the scene changes continually, causing the autofocus process to pause.

17. The method of claim 15, further comprising commencing the autofocus process upon determining that there is no substantial change in the exposure characteristic of the scene.

18. The method of claim 1, wherein initiating an autofocus process comprises adjusting a focus setting of the image capture device by changing a position of a lens of the image capture device relative to an image sensor of the image capture device.

19. A non-transitory computer-readable medium comprising machine-readable code which, when executed by a processor, causes the processor to perform the method of claim 1.

20. An apparatus for processing image data, the apparatus comprising processing circuitry to:
determine if at least one initiation condition is met, by:
obtaining a first contrast metric representative of a contrast characteristic of at least one region of a first image captured with a first focus setting, the first contrast metric being determined based on one or more first data values corresponding to one or more pixels of the first image;
determining a change in the contrast characteristic of the at least one region of the first image based on the first contrast metric with respect to a reference contrast metric obtained from a previous image captured with the first focus setting;
determining if the change in the contrast characteristic equals to or exceeds an initiation threshold for the first focus setting, the initiation threshold for the first focus setting being set based at least in part on the first focus setting; and
upon determining that at least one initiation condition is met, initiate an autofocus process.
